(19) United States
(12) Patent Application Publication
(10) Pub. No.: US 2002/0129931 A1
(43) Pub. Date: Sep. 19, 2002

(54) Air conditioner and arrangement structure in vehicle

(76) Inventors: Osamu Nagata, Ichinomiya-city (JP); Tomohiro Takeo, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/093,590

(22) Filed: Mar. 8, 2002

(30) Foreign Application Priority Data
Mar. 16, 2001 (JP) 2001-76957

(51) Int. Cl. B60H 3/00; B61D 27/00; B60H 1/02; B60H 1/22; B60H 1/00

(52) U.S. Cl. 165/202; 165/42; 165/43; 454/160; 454/156; 454/161

(57) ABSTRACT

In a vehicle air conditioner, an interior unit for performing air-conditioning operation in a passenger compartment is disposed inside an instrument panel of the vehicle. A blower is disposed at a vehicle rear side in the interior unit, and a heat-exchanging member for performing a heat exchange with air is disposed in the interior unit at a vehicle front side of the blower. Because the blower and the heat-exchanging member are arranged in the vehicle front-rear direction, a vertical dimension of the interior unit can be made smaller.

### CROSS-REFERENCE TO RELATED APPLICATION

This application is related to Japanese Patent Application No. 2001-76957 filed on Mar. 16, 2001, the contents of which are hereby incorporated by reference.

### BACKGROUND OF THE INVENTION

1. Field of the Invention

The present invention relates to an interior unit of a vehicle air conditioner, disposed inside an instrument panel within a passenger compartment.

2. Description of Related Art

In a conventional vehicle air conditioner described in JP-A-6-156049, heat exchangers are disposed to be stacked above a blower in an interior unit disposed inside an instrument panel. Therefore, a vertical dimension of the interior unit becomes larger. In addition, in the vehicle air conditioner, because a heating heat exchanger is disposed at a front side within the space of the interior unit, warm air heated in the heating heat exchanger readily flows into a defroster opening. That is, because the defroster opening is provided at a vehicle front side from a foot opening in the interior unit, the temperature of air blown from the defroster opening becomes higher than the temperature of air blown from the foot opening in an air outlet mode (e.g., foot mode, foot/defroster mode) where air is blown from both the defroster opening and the foot opening. Therefore, the face of a passenger may readily sense hot feeling.

### SUMMARY OF THE INVENTION

In view of the foregoing problems, it is an object of the present invention to provide a vehicle air conditioner including an interior unit that has a reduced vertical dimension and is readily disposed inside an instrument panel.

It is an another object of the present invention to provide an arrangement of an interior unit disposed inside the instrument panel, which can restrict air blown from a defroster opening from giving a hot feeling to the face of a passenger.

According to the present invention, in air conditioner for a vehicle, an interior unit is disposed inside an instrument panel of the vehicle for performing air-conditioning operation of the passenger compartment. In the interior unit, a blower for blowing air is disposed at a vehicle rear side, and a heat-exchanging member for performing a heat exchange with air blown by the blower is disposed at a vehicle front side of the blower. Accordingly, the blower and the heat-exchanging member are arranged in a vehicle front-rear direction without being stacked in an up-down direction. Therefore, the interior unit can be readily mounted inside the instrument panel, and a foot space for a passenger in the passenger compartment can be readily provided under the instrument panel. Further, because the blower is positioned at the vehicle rear side of the heat-exchanging member, a blower maintenance operation such as a check of the blower can be readily performed.

The heat-exchanging member includes a cooling heat exchanger for cooling air from the blower and a heating heat exchanger for heating air from the cooling heat exchanger. Preferably, the heating heat exchanger is disposed above the cooling heat exchanger at a vehicle rear side position of the cooling heat exchanger, and an air mixing door is disposed at a vehicle front side of the heating heat exchanger in such a manner that the bypass passage is provided above the heating heat exchanger on the vehicle front side of the heating heat exchanger. The interior unit further includes a mode switching portion disposed at a downstream air side of the heating heat exchanger and the bypass passage. Further, the mode switching portion has a foot opening through which air is blown toward a lower side in the passenger compartment, a face opening through which air is blown toward an upper side in the passenger compartment, and a defroster opening through which air is blown toward an inner surface of a windshield of the vehicle. More preferably, the foot opening is provided at a vehicle rear side from the defroster opening. Accordingly, warm air passing through the heating heat exchanger readily flows toward the foot opening, and cool air passing through the bypass passage readily flows into the defroster opening. As a result, in a mode such as a foot/defroster mode, where conditioned air is blown from both the foot opening and the defroster opening, the temperature of air blown from the foot opening can be made higher than the temperature of air blown from the defroster opening, and a comfortable temperature distribution of “cool-head and warm-foot” can be obtained.

### BRIEF DESCRIPTION OF THE DRAWINGS

Additional objects and advantages of the present invention will be more readily apparent from the following detailed description of preferred embodiments when taken together with the accompanying drawings, in which:

FIG. 1 is a schematic sectional view showing an interior unit of a vehicle air conditioner according to a first preferred embodiment of the present invention;

FIG. 2 is a front view of the interior unit of FIG. 1 when being viewed from an interior of a passenger compartment;

FIG. 3 is a cross-sectional view taken along line III-III in FIG. 1; and

FIG. 4 is a schematic front view of an interior unit of a vehicle air conditioner when being viewed from an interior of the passenger compartment, according to a second preferred embodiment of the present invention.

### DETAILED DESCRIPTION OF THE PRESENTLY PREFERRED EMBODIMENTS

Preferred embodiments of the present invention will be described hereinafter with reference to the accompanying drawings.

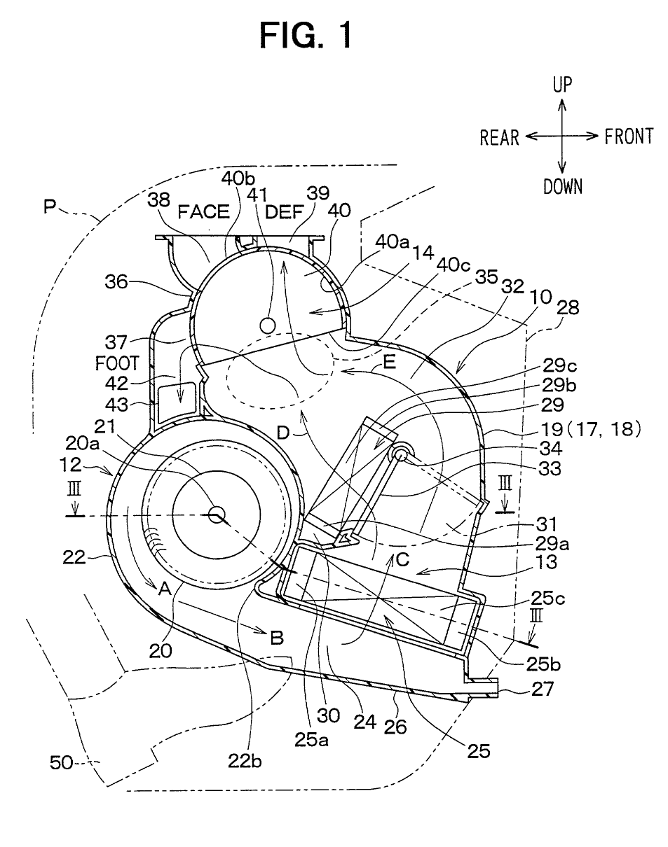

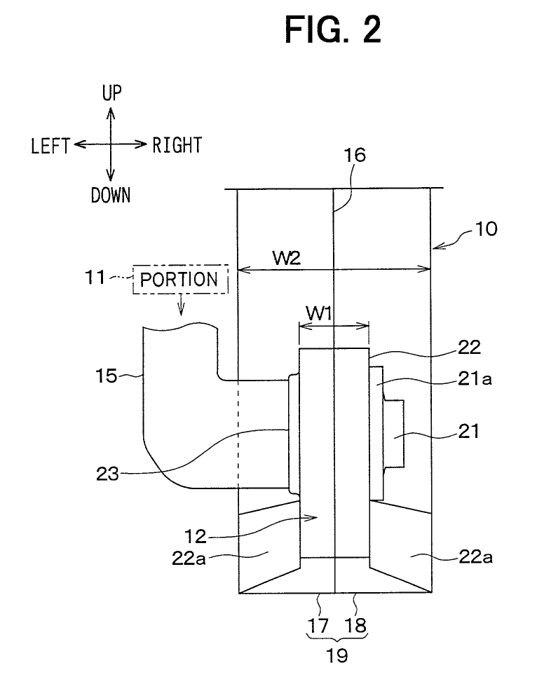

A first preferred embodiment of the present invention will be now described with reference to FIGS. 1-3. In the first embodiment, an interior unit 10 of a vehicle air conditioner is disposed at an approximate center position in a width direction (right-left direction) within an instrument panel P (dashboard) provided at a front side in a passenger compartment. The interior unit 10 is mounted on a vehicle to correspond to the arrangement of FIGS. 1 and 2 in the vehicle up-down direction, in the vehicle front-rear direction and in the vehicle right-left direction.

The interior unit 10 of the first embodiment includes an inside/outside air switching portion 11 (FIG. 2), a blower 12, a heat-exchanging member 13 and a mode switching portion 14. An outlet passage portion of the inside/outside air switching portion 11 and a suction portion of the blower 12 is connected by a connection duct 15.

As shown in FIG. 2, in the interior unit 10, a case 19 defining an air passage is constructed by integrally connecting left and right division case members 17, 18 divided at a division surface 16 at an approximate center position in the width direction. Each of the left and right division case members 17, 18 is made of resin, which has an elasticity to some degree and is superior in a strength, such as polypropylene. In the inside/outside air switching portion 11, inside air or/and outside air can be selectively introduced by an inside/outside air switching door (not shown).

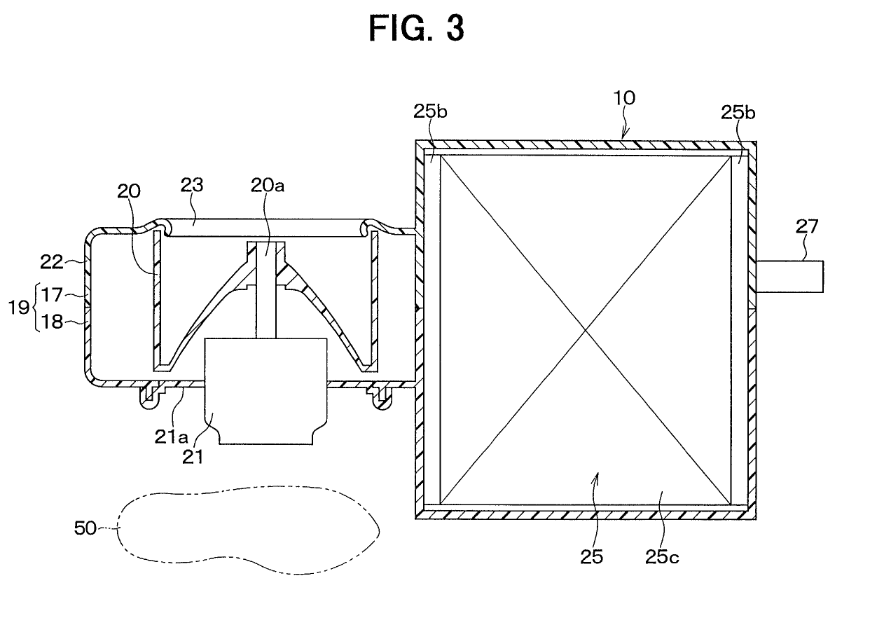

As shown in FIG. 2, the blower 12 is disposed at a lower side position in the interior unit 10 on a vehicle rear side (the passenger's side). The blower 12 includes a centrifugal multi-blades fan (sirocco fan) 20, a motor 21 for driving the fan 20, and a screw casing 22. The fan 20 is disposed, so that a rotation shaft 20a is in the vehicle width direction, and a suction port 23 (see FIGS. 2 and 3) of the fan 20 is opened toward a side in the vehicle width direction.

In the first embodiment, one of openings provided on both right and left side surfaces of the scroll casing 22 is used as the suction port 23. Specifically, in a vehicle having a right steering wheel, as shown in FIG. 2, the left side opening of the scroll casing 22 is used as the suction port 23, and the motor 21 for driving the fan 20 is disposed at the right side of the scroll casing 22 so that the right side opening of the scroll casing 22 is closed by a flange portion 21a of the motor 21. Conversely, in a vehicle having a left steering wheel, the right side opening of the scroll casing 22 is used as the suction port 23, and the motor 21 for driving the fan 20 is disposed at the left side of the scroll casing 22 so that the left side opening of the scroll casing 22 is closed by the circular flange portion 21a of the motor 21.

For example, a width dimension W1 of the scroll casing 22 is about 100 mm, that is greatly smaller than a width dimension W2 (e.g., about 200 mm) of the interior unit 10. The outlet side of the scroll casing 22 is enlarged toward the width dimension of the interior unit 10. In FIGS. 2 and 3, an expansion portion 22a enlarged from the outlet side of the scroll casing 22 is indicated.

As shown in FIGS. 2 and 3, the scroll casing 22 and the fan 20 disposed within the scroll casing 22 are positioned at an approximate center portion of the interior unit 10 in the width direction. Further, as shown in FIG. 1, a nose portion 22b used as a winding start portion of a scroll shape of the scroll casing 22 is positioned at a vehicle front side relative to the fan 20. Accordingly, by the rotation of the fan 20 as shown by the arrow A in FIG. 1, suction air sucked from the suction port 23 is blown from a vehicle rear side to a vehicle front side as shown by the arrow B in FIG. 1, and is blown to a bottom side (a side under an evaporator 25) within the case 19 of the interior unit 10.

Next, the heat exchanging portion 13 disposed within the case 19 of the interior unit 10 will be now described. The heat-exchanging member 13 is disposed at a vehicle front side of the blower 12. In the first embodiment of the present invention, the heat-exchanging member 13 includes an evaporator 25 used as a cooling heat exchanger, and a heater core 29 used as a heating heat exchanger. An inlet passage 24 extending from the outlet side of the scroll casing 22 of the blower 12 toward the vehicle front is provided at the most bottom side of the case 19 under the evaporator 25. That is, the evaporator 25 is disposed above the inlet passage 24. The evaporator 25 has substantially a thin rectangular shape, and is disposed approximately horizontally at an upper position separated from a bottom portion 26 of the case 19 by a predetermined height. In the first embodiment, the evaporator 25 is not disposed strictly horizontally, but is tilted downwardly at a downstream air side from a horizontal direction by a small angle.

Low-pressure refrigerant decompressed in a decompression unit of a refrigerant cycle is introduced into the evaporator 25. In the evaporator 25, low-pressure refrigerant is evaporated by absorbing heat from air, so that air passing through the evaporator 25 is cooled. Because the evaporator 25 is tilted slightly downwardly from the vehicle rear side to the vehicle front side, condensed water generated in the evaporator 25 is collected to a downstream air side along the air flow, and is smoothly discharged to a bottom side from a tilted lower end. Because the bottom portion 26 of the case 19, positioned under the evaporator 25, constructs a receiving portion of condensed water, the bottom portion 26 is also tilted downwardly from the horizontal direction toward the downstream air side (vehicle front side) by a small angle, similarly to the arrangement of the evaporator 25.

Thus, a front side end of the bottom portion 26 becomes a lowest portion, and a discharge pipe 27 for discharging condensed water to an outside is provided at the lowest portion. The discharge pipe 27 is formed to protrude to a vehicle front side. Specifically, the discharge pipe 27 penetrates through a through hole provided in a partition wall (dashboard) for partitioning the passenger compartment and an engine compartment from each other, to directly protrudes into the engine compartment.

The evaporator 25 has a core portion 25c disposed between two tank portions 25a, 25b. The core portion 25c is constructed by alternatively stacking and joining plural flat tubes and plural corrugated fins. The evaporator 25 is disposed, so that air in the inlet passage 24 passes through the core portion 25c from below upwardly as shown by the arrow C in FIG. 1.

The heater core 29 is disposed approximately vertically within the case 19, at a downstream air side of the evaporator 25 above the evaporator 25. As shown in FIG. 1, a heat-exchanging surface of the heater core 29 is positioned to have an approximate right angle relative to a heat-exchanging surface of the evaporator 25, at a vehicle rear-side position of the evaporator 25. In the first embodiment, the heater core 29 is a heating heat exchanger for heating air passing therethrough using hot water from a vehicle engine as a heating source.

The heater core 29 includes a core portion 29c disposed between a hot-water inlet tank 29a and a hot water outlet tank 29b. The core portion 29c is constructed by alternatively stacking and joining plural flat tubes and plural corrugated fins.

For example, the heater core 29 is a one-way flow type (whole pass type) in which hot water from the hot-water inlet tank 29a flows through the whole flat tubes in one way toward the hot-water outlet tank 29b. That is, hot water flows through the whole flat tubes from below upwardly.

Relative to the evaporator 25 disposed approximately horizontally, the heater core 29 is disposed approximately vertically. Here, a lower end (e.g., hot-water inlet tank 29a) of the heater core 29 is disposed at a position proximate to one end of the evaporator 25 in the horizontal direction. As shown in FIG. 1, a predetermined clearance 30 is provided between the tank portion 25a at the one end side of the evaporator 25 and the hot-water inlet tank 29a at the lower end of the heater core 29, so that a heat insulation is performed between the evaporator 25 and the heater core 29 through the predetermined clearance 30.

According to the first embodiment of the present invention, the lower end of the heater core 29 is disposed near the vehicle rear side end of the evaporator 25 in the horizontal direction, and the heater core 29 is disposed approximately vertically above the evaporator 25. Therefore, a space 31 extending vertically in parallel with the heat-exchanging surface of the core portion 29c of the heater core 29 can be provided at a vehicle front side position of the heater core 29. A cool air bypass passage 32, through which cool air having passed through the evaporator 25 flows as shown by the arrow E in FIG. 1 while bypassing the heater core 29, is provided at an upper side of the heater core 29 on the vehicle front side from the heater core 29.

A rotation shaft 34 of an air-mixing door 33 is disposed at a front side position of the heater core 29 around an upper side end of the heater core 29. The rotation shaft 34 is disposed to extend in the vehicle width direction, and is held in the case 19 to be rotatable by a bearing hole provided in a wall portion of the case 19. An upper end portion of the air mixing door 33 is integrally connected with the rotation shaft 34, so that the air mixing door 33 is rotated around the rotation shaft 34 between the solid line position and the chain line position in FIG. 1. For example, the air mixing door 33 is formed in a plate like.

When the air mixing door 33 is at the solid line position in FIG. 1 (maximum cooling position), all the air passage of the core portion 29c of the heater core 29 is fully closed. On the other hand, when the air mixing door 33 is at the chain line in FIG. 1 (maximum heating position), the cool-air bypass passage 32 is fully closed so that all air passes through the heater core 29. When the air mixing door 33 opens the air passage of the core portion 29c of the heater core 29, air in the space 31 passes through the core portion 29c from a vehicle front side to a vehicle rear side as shown by the arrow D in FIG. 1.

The air-mixing door 33 adjusts a ratio between an amount of warm air passing through the core portion 29c of the heater core 29 and an amount of cool air passing through the cool-air bypass passage 32 while bypassing the heater core 29, so that the temperature of air blown into the passenger compartment is adjusted.

An air mixing portion 35 is provided within the case 19 at a vehicle rear upper side of the heater core 29 and the cool-air bypass passage 32, so that warm air from the heater core 29 and cool air from the cool-air bypass passage 32 are mixed in the air mixing portion 35 to have a predetermined temperature.

The mode switching portion 14 is disposed at an upper rear side of the air mixing portion 35. In the first embodiment, the mode switching portion 14 has an approximate semi-cylindrical seal surface 36 that extends in the vehicle width direction and is formed at an upper position of the case 19. A foot opening 37 is provided in a vehicle rear-side surface among the seal surface 36, a face opening 38 is provided at an upper side position of the foot opening 37 in the seal surface 36, and a defroster opening 39 is provided at a vehicle front-side position of the face opening 38 in the seal surface 36.

Inside the semi-cylindrical seal surface 36, a mode switching door 40 is disposed rotatably to be rotated around a rotation shaft 41. In the first embodiment, the mode switching door 40 is a rotary door with a door body 40a, for example. The door body 40a has a circumference wall surface with a predetermined curvature around the rotation shaft 41. A communication hole 40b is provided in the door body 40a at a predetermined position in the circumference direction. Accordingly, by the rotation of the door body 40a, the openings 37-39 can be selectively opened and closed.

The foot opening 37 communicates with a foot outlet 43, provided at right and left sides in the vehicle width direction, through a foot air passage 42, so that air is blown toward the foot area of a passenger in the passenger compartment from the foot air outlet 43. The face opening 38 is for blowing air toward the face area of the passenger in the passenger compartment through a face duct. Further, the defroster opening 39 is for blowing air toward an inner surface of a front windshield through a defroster duct.

The mode switching door 40 is connected to a mode operation mechanism through a link mechanism, to be rotated and operated by a mode operation mechanism. Similarly, the rotation shaft 34 of the air mixing door 33 is connected to a temperature-adjustment operation mechanism through a like mechanism, so that an opening degree of the air mixing door 33 is adjusted by the temperature-adjustment operation mechanism.

Each of the mode operation mechanism and the temperature-adjustment operation mechanism may be an automatic operation mechanism using a servo motor, or may be a manual operation mechanism manually operated by a manual operation of a passenger.

Next, operation of the interior unit 10 according to the first embodiment will be now described. When the fan 20 is rotated by the motor 21 in the arrow A direction, inside air or outside air is sucked from the inside/outside air switching portion 11, and is introduced into the suction port 23 of the scroll casing 22 through the connection duct 15.

Then, the sucked air is blown into the scroll casing 22 by the fan 20, and is blown from the vehicle rear side to the vehicle front side as shown by the arrow B in FIG. 1. Air blown by the fan 20 is introduced into the inlet passage 24 under the evaporator 25 from the vehicle rear side to the vehicle front side, and passes through the evaporator 25 upwardly from below as shown by the arrow C in FIG. 1 to be cooled. Next, air from the evaporator 25 is divided into cool air E passing through the cool-air bypass passage 32 and warm air D passing through the heater core 29 based on the opening degree of the air mixing door 33. That is, a ratio between the air amount passing through the heater core 29 and the air amount passing through the cool-air bypass passage 32 is adjusted, so that condensed air having a predetermined temperature can be obtained in the air mixing portion 35.

The mode switching door 40 is operated to selectively open and close the foot opening 37, the face opening 38 and the defroster opening 39, so that air is blown into the passenger compartment from at least one of the openings 37-39 to perform air-conditioning operation in the passenger compartment.

Specifically, in a face mode, the communication hole 40b of the door body 40a of the mode switching door 40 communicates with the face opening 38 as shown in FIG. 1, so that conditioned air is blown toward the face area of the passenger in the passenger compartment through the face opening 40. In a bi-level mode, the communication hole 40b of the door body 40a of the mode switching door 40 communicates with both the foot opening 37 and the face opening 38, so that conditioned air is blown toward both the foot area and the face area of the passenger in the passenger compartment through the foot opening 37 and the face opening 38.

In a foot mode, the communication hole 40b of the door body 40a of the mode switching door 40 communicates with the foot opening 37, so that conditioned air is blown toward the foot area of the passenger in the passenger compartment through the foot opening 37. In the foot mode, the defroster opening 39 is slightly opened by an open end surface 40c of the door body 40a, so that a slight amount of conditioned air is also blown toward the inner surface of the windshield through the defroster opening 39 to defrost the windshield.

In a foot/defroster mode, the foot opening 37 becomes in a half-open state by the communication hole 40b of the door body 40a of the mode switching door 40, and the defroster opening 39 also becomes in a half-open state by the open end surface 40c of the door body 40a, so that conditioned air is blown from each of the foot opening and the defroster opening by about 50% degrees. Accordingly, in the foot/defroster mode, the foot area of the passenger in the passenger compartment can be heated while the windshield is defrosted.

In the first embodiment of the present invention, the heater core 29 is disposed at a side of the foot opening 37, and the cool-air bypass passage 32 is disposed at a side of the defroster opening 39. Therefore, in the foot/defroster mode, when the air mixing door 33 is operated at a position between the maximum heating position and the maximum cooling position, warm air D passing through the heater core 29 mainly flows toward the foot opening 37, and cool air E passing through the cool-air bypass passage 32 flows into the defroster opening 39. Accordingly, the temperature of air blown toward the foot area in the passenger compartment can be set lower than the temperature of air blown toward the windshield, and a temperature distribution of “cool-heat and warm-foot” can be obtained.

According to the first embodiment of the present invention, the blower 12 is disposed at a lower rear side in the interior unit 10, and the heat-exchanging member 13 is disposed at a vehicle front side from the blower 12. That is, the blower 12 and the heat-exchanging member 13 is arranged in the vehicle front-rear direction. Therefore, the vertical dimension of the interior unit 10 can be reduced. Accordingly, the interior unit 10 can be readily mounted inside the instrument panel P, and a foot space for the passenger in the passenger compartment can be readily provided in the passenger compartment. In addition, the width dimension W1 of the blower 12 is set smaller than the width dimension W2 of the interior unit 10, the foot space for the passenger can be readily provided. In FIGS. 1, 3, a foot 50 for the passenger in the passenger compartment is indicated. In addition, as shown in FIG. 2, the blower 12 is disposed so that the radial direction of the blower 12 is in a direction perpendicular to the horizontal direction and the rotation shaft 20a is in the horizontal direction.

Because the blower 12 is disposed at the vehicle lower rear side in the interior unit 10, the blower 12 can be readily checked by an operator. Therefore, maintenance operation of the blower 12 can be improved.

Further, as shown in FIG. 1, the fan 20 disposed within the scroll casing 22 is disposed at an upper side from the evaporator 25. Therefore, it can prevent condensed water generated on the evaporator 25 from being introduced into the fan 20.

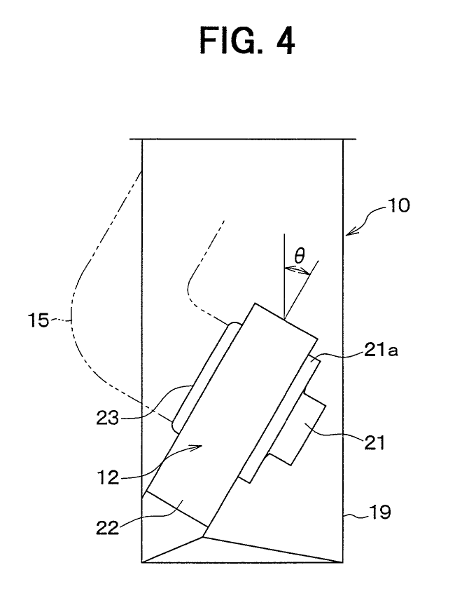

A second preferred embodiment of the present invention will be now described with reference to FIG. 4. In the above-described first embodiment of the present invention, the blower 12 is disposed so that the radial direction of the blower 12 is perpendicular to the horizontal direction and the rotation shaft 20a is in the horizontal direction. However, in the second embodiment, as shown in FIG. 4, the radial direction of the blower is tilted from the vertical direction by a predetermined angle θ.

Even in the tilted arrangement of the blower 12, when the blower 12 is disposed at the vehicle lower rear side in the interior unit and the heat-exchanging member 13 is disposed at the vehicle front side from the blower 12, the advantage similar to the first embodiment can be obtained.

Although the present invention has been fully described in connection with the preferred embodiments thereof with reference to the accompanying drawings, it is to be noted that various changes and modifications will become apparent to those skilled in the art.

For example, in the above-described first embodiment of the present invention, the air mixing door 33 is used as a temperature adjustment unit for adjusting the temperature blown into the passenger compartment. However, as the temperature adjustment unit, a hot water valve for adjusting a flow amount or a temperature of hot water flowing into the heater core 29 can be used.

In the first embodiment of the present invention, the heat core 29 is disposed above the evaporator 25 so that an extension line of the heat-exchanging surface of the heater core 29 crosses with that of the heat-exchanging surface by an approximate right angle. However, the heater core 29 may be disposed above the evaporator 25 approximately horizontally. In this case, a slide door sliding along a heat-exchanging surface of the core portion 29c of the heater core 29 can be used. In addition, a plate-like door may be used as the mode switching door 40. Even in this case, the present invention can be also applied.

Such changes and modifications are to be understood as being within the scope of the present invention as defined by the appended claims.

What is claimed is:

1. An air conditioner for a vehicle having a passenger compartment, comprising
an interior unit, disposed inside an instrument panel of the vehicle, for performing air-conditioning operation of the passenger compartment, the interior unit including:
a blower for blowing air, the blower being disposed at a vehicle rear side in the interior unit; and
a heat-exchanging member for performing a heat exchange with air blown by the blower,
wherein the heat-exchanging member is disposed at a vehicle front side of the blower.

2. The air conditioner according to claim 1, wherein:
the heat-exchanging member includes a cooling heat exchanger, disposed approximately horizontally, for cooling air blown by the blower; and
the cooling heat exchanger is disposed relative to the blower in such a manner that, air blown by the blower flows from a vehicle rear side to a vehicle front side to be introduced below the cooling heat exchanger, and passes through the cooling heat exchanger upwardly from below.

3. The air conditioner according to claim 2, wherein:
the interior unit has a case for defining an air passage, the case having a bottom surface portion under the cooling heat exchanger;
the cooling heat exchanger is disposed in the case to be tilted downwardly from the vehicle rear side to the vehicle front side; and
the bottom surface portion under the cooling heat exchanger is disposed to be tilted downwardly from the vehicle rear side to the vehicle front side, the air conditioner further comprising:
a discharge pipe for discharging condensed water generated from the cooling heat exchanger to an outside, the discharge pipe being disposed at a front end in the bottom surface portion of the case.

4. The air conditioner according to claim 1, wherein:
the heat-exchanging member further includes a cooling heat exchanger for cooling air from the blower, a heating heat exchanger for heating air from the cooling heat exchanger, and an air mixing door for adjusting a ratio between an air amount passing through the heating heat exchanger and an air amount bypassing the heating heat exchanger; and
the heating heat exchanger is disposed at an upper side of the cooling heat exchanger to form a bypass passage through which air from the cooling heat exchanger flows while bypassing the heating heat exchanger.

5. The air conditioner according to claim 4, wherein:
the heating heat exchanger is disposed above the cooling heat exchanger at a vehicle rear side position of the cooling heat exchanger; and
the air mixing door is disposed at a vehicle front side of the heating heat exchanger in such a manner that the bypass passage is provided above the heating heat exchanger.

6. The air conditioner according to claim 5, wherein:
the heating heat exchanger has a bottom end disposed at a position proximate to a rear side end of the cooling heat exchanger; and
a heat-exchanging surface of the heating heat exchanger is positioned by an approximate right angle relative to a heat-exchanging surface of the cooling heat exchanger.

7. The air conditioner according to claim 5, wherein:
the interior unit further including a mode switching portion disposed at a downstream air side of the heating heat exchanger and the bypass passage;
the mode switching portion has a foot opening through which air is blown toward a lower side in the passenger compartment, a face opening through which air is blown toward an upper side in the passenger compartment, and a defroster opening through which air is blown toward an inner surface of a windshield of the vehicle; and
the foot opening is provided at a vehicle rear side from the defroster opening.

8. The air conditioner according to claim 7, wherein the mode switching portion is disposed at an upper side from the blower.

9. The air conditioner according to claim 1, wherein:
the blower includes a centrifugal fan for blowing air, a motor for driving the fan, and a scroll casing for accommodating the fan;
the heat-exchanging member includes a cooling heat exchanger for cooling air from the blower; and
the fan of the blower is positioned at an upper side of the cooling heat exchanger.

10. The air conditioner according to claim 9, wherein the scroll casing has a width dimension in a vehicle width direction, that is set to be positioned within a width dimension of the interior unit in the vehicle width direction.

11. The air conditioner according to claim 9, wherein an axial line of the centrifugal fan is positioned in a vehicle width direction.

12. The air conditioner according to claim 9, wherein an axial line of the centrifugal fan is tilted relative to a horizontal direction.

13. An arrangement structure of an air conditioner in a vehicle having a passenger compartment, comprising
an interior unit, disposed inside an instrument panel of the vehicle within the passenger compartment, for performing air-conditioning operation of the passenger compartment, the interior unit including:
a blower for blowing air, the blower being disposed at a vehicle rear side in the interior unit; and
a heat-exchanging member for performing a heat exchange with air blown by the blower,
wherein the heat-exchanging member is disposed at a vehicle front side of the blower.

14. The arrangement structure according to claim 13, wherein:
the heat-exchanging member includes a cooling heat exchanger, disposed approximately horizontally, for cooling air blown by the blower; and
the cooling heat exchanger is disposed relative to the blower in such a manner that, air blown by the blower flows from a vehicle rear side to a vehicle front side to be introduced below the cooling heat exchanger, and passes through the cooling heat exchanger upwardly from below.

15. The arrangement structure according to claim 13, wherein:
the heat-exchanging member further includes a cooling heat exchanger for cooling air from the blower, a heating heat exchanger for heating air from the cooling heat exchanger, and an air mixing door for adjusting a ratio between an air amount passing through the heating heat exchanger and an air amount bypassing the heating heat exchanger; and
the heating heat exchanger is disposed at an upper side of the cooling heat exchanger to form a bypass passage through which air from the cooling heat exchanger flows while bypassing the heating heat exchanger.

16. The arrangement structure according to claim 15, wherein:
the heating heat exchanger is disposed above the cooling heat exchanger at a vehicle rear side position of the cooling heat exchanger; and
the air mixing door is disposed at a vehicle front side of the heating heat exchanger in such a manner that the bypass passage is provided above the heating heat exchanger.

17. The arrangement structure according to claim 16, wherein:
the heating heat exchanger has a bottom end disposed at a position proximate to a rear side end of the cooling heat exchanger; and
a heat-exchanging surface of the heating heat exchanger is positioned by an approximate right angle relative to a heat-exchanging surface of the cooling heat exchanger.
